(19) United States
(12) Patent Application Publication
(10) Pub. No.: US 2001/0031362 A1
(43) Pub. Date: Oct. 18, 2001

(54) Low VOC coating composition

(75) Inventors: Sam Abrami, Glendale, CA (US); Jak Aklian, North Hollywood, CA (US); Adrian Balladares, Playa Del Rey, CA (US); Anni Kazorian, Glendale, CA (US)

Correspondence Address: FINNEGAN, HENDERSON, FARABOW, GARRETT &, DUNNER LLP, 1300 I STREET, NW, WASHINGTON, DC, 20005, US

(73) Assignee: PRC-DeSoto International, Inc.

(21) Appl. No.: 09/863,048

(22) Filed: May 22, 2001

Related U.S. Application Data
(63) Continuation of application No. 09/207,738, filed on Dec. 8, 1998.
(60) Provisional application No. 60/070,929, filed on Dec. 24, 1997.

(51) Int. Cl. B32B 27/38; C08K 3/20; C08L 63/00

(52) U.S. Cl. 428/413; 523/402; 523/425

(57) ABSTRACT

A water based, low VOC coating includes an aqueous dispersion of an amine terminated epoxy resin and an organosilane curing agent of the formula: R¹—(CH₂)ₓ—Si—(R³)ₙ—(R²)₃₋ₙ; wherein R¹ is an epoxide, an isocyanate, or an acrylic; R² is an alkoxy group, acetoxy group, or an oximino group; R³ is a C₁—C₆ alkyl group; X is an integer from 2-10; and n is 0 to 2.

### RELATED APPLICATION

This application claims priority of U.S. Provisional Application Serial No. 60/070,929 filed Dec. 24, 1997.

### FILED OF THE INVENTION

This invention relates generally to coatings. More specifically, the invention relates to a flexible, chemically resistant epoxy based coating composition. Most specifically, the invention relates to an aqueous based epoxy coating composition having a low concentration of VOCs therein.

### BACKGROUND OF THE INVENTION

Epoxy based coatings generally have high resistance to chemical attack, and good flexibility which makes them very useful in a variety of industrial applications. Initially, many epoxy based coatings were prepared from organic solvent based systems. Such compositions generally have long pot life and fast dry times; but they contain high levels of organic solvents which are expensive and subject to governmental regulation. As a consequence, the industry has looked to use coating compositions which have low concentrations of volatile organic compounds (VOCs). Water based coatings are very attractive for this reason, but have generally been found to have short pot life, slow cures and marginal chemical resistance. In addition, water based epoxy coatings are difficult to prepare and use, since they do not wet a substrate very well, and usually require the addition of surface tension lowering additives such as silicones to improve flow and coating appearance. Such additives often cause intercoat adhesion problems.

### DETAILED DESCRIPTION OF THE INVENTION

The present invention is directed to water based, low VOC epoxy coatings which have long pot life, fast dry time and very good chemical and water resistance once cured. The coatings of the present invention are also easy to mix and have good application properties.

The coatings of the present invention are formed from a first component which comprises a water based dispersion of an amine terminated epoxy resin. By water based dispersion is meant a multi-phase mixture of water and organic compounds, and may comprise an emulsion, a colloid, or a microgel, all of which are known in the art. The invention may be practiced with any amine terminated epoxy resin that is chemically stable under the conditions set forth herein. One particularly preferred group of resins are those which are disclosed in U.S. Pat. No. 5,369,152; although, other such resins will be readily apparent to one of skill in the art.

The second major component of the composition of the present invention comprises a curing agent which is an organosilane of the general structural formula: R¹—(CH₂)ₓ—Si—(R³)ₙ—(R²)₃₋ₙ; wherein R¹ is an epoxide, an isocyanate, or an acrylic; R² is an alkoxy group, acetoxy group, or an oximino group; R³ is a C₁—C₆ alkyl group; X is an integer from 2-10; and n is 0 to 2.

R¹ can be an alkyl group, a cycloalkyl group, or an aryl group which contains an epoxy group, an isocyanate group, an acrylic group or a methacrylic group.

There are a number of curing agents which will be readily apparent to one of skill in the art. Among some of the most preferred curing agents are gamma-glycidoxypropyl trimethoxysilane; and beta (3,4-epoxycyclohexyl) ethyltrimethoxy silane. Some other preferred curing agents are gamma-methacryloxypropyl trimethoxy silane; and gamma-isocyanatopropyl triethoxysilane.

In a typical composition, an aqueous dispersion of the amine terminated epoxy resin will further include an organic co-solvent in an amount, by weight, of 0 to 80% of the dispersion. This solvent preferably comprises a water compatible solvent such as a glycol ether or an alcohol. The dispersion may further include a pigment, which is typically present in an amount of 0 to 60% by weight of the dispersion.

The curing agent may further include an organic co-solvent in an amount of 0 to 90% by weight. This co-solvent is again preferably a water compatible solvent such as a glycol ether, an alcohol or the like. The curing agent can also be a non-water compatible solvent including ketones such as methylamylketone and alcohols such as n-butanol. The curing agent may also include 0 to 50% by weight of a pigment, and 0 to 10% of a surfactant. Additionally, it has been found that it may be necessary to increase the amount of water in the mixture of aqueous dispersion and the curing agent in the composition in order to reduce the viscosity of the composition for a desired application or mechanism of application such as spraying.

A variety of formulations may be prepared in accord with the foregoing. It is believed that the curing of the coatings takes place in four stages. The first stage involves evaporation of the water and any organic co-solvent. The second stage involves coalescence or aggregation of the dispersed, amine terminated resin particles. The third stage of the curing involves a reaction of the organo-functional end of the silane with the amine hydrogen of the resin. A fourth stage of the reaction involves a further cross-linking wherein the alkoxysilane groups condense with either another alkoxysilane or with a substrate, on which the coating is disposed.

The Examples include five illustrative formulations made in accord with the principles of the present invention. In these formulations, the amine terminated resin component is set forth as component A, and the curing agent as component B. In the following formulations, amine terminated resins are commercially available products sold by the Reichold Chemical Company under the trademark EPOTUF. Other materials include glycol ether co-solvents available from the Arco Chemical Company under the name ARCOSOLVE and from the Dow Chemical Company under the name DOWANOL. The compositions also include pigments and water as indicated.

### EXAMPLE 1

Formulation #1

| Component A | | Component B | |
|---|---|---|---|
| Material | Lbs | Material | Lbs |
| Epotuf 37-681 | 188.3 | Epoxy Silane | 70 |
| Arcosolve PTB | 37.7 | Arcosolve PTB | 10 |
| Dowanol PPh | 11.3 | | 80 |
| Raven 410 | 20.1 | | |
| Wollastokup 10ES | 316.8 | | |
| | -Mix and Grind- | | |
| Epotuf 37-681 | 228.2 | | |
| Arcosolve PTB | 27.3 | | |
| Water | 27.7 | | |
| | 857.5 | | |

### EXAMPLE 2

Formulation #2

| Component A | | Component B | |
|---|---|---|---|
| Material | Lbs | Material | Lbs |
| Epotuf 37-680 | 160.7 | Epoxy Silane | 40 |
| Arcosolve PTB | 21.9 | Methacryl Silane | 30 |
| Dowanol PPh | 8.8 | Arcosolve PTB | 20 |
| Strontium Chromate | 94.3 | | 90 |
| Ti-Pure R-900 | 169.7 | | |
| Wollastokup 10ES | 221.5 | | |
| | -Mix and Grind- | | |
| Epotuf 37-680 | 162.9 | | |
| Arcosolve PTB | 26.6 | | |
| Water | 154.7 | | |
| | 1021.1 | | |

### EXAMPLE 3

Formulation #3

| | |
|---|---|
| Component A | Component B |

| Material | Lbs | Material | Lbs |
|---|---|---|---|
| Epotuf 37-680 | 160.0 | Epoxy Silane | 28.0 |
| Arcosolve PTB | 10.0 | Ektosolve EB | 5.0 |
| Dowanol PPh | 5.0 | | 33.0 |
| Water | 50.0 | | |
| | 225.0 | | |

### EXAMPLE 4

Formulation #4

| Component A | | Component B | |
|---|---|---|---|
| Material | Lbs | Material | Lbs |
| Epotuf 37-681 | 148.0 | Epoxy Silane | 52 |
| Arcosolve PTB | 20.0 | Ektosolve EB | 10 |
| Dowanol PPh | 8.1 | | 62 |
| Ektosolve EB | 5.0 | | |
| Yellow Iron Oxide | 71.0 | | |
| Black Iron Oxide | 16.0 | | |
| Wollastokup 10ES | 290.0 | | |
| | -Mix and Grind- | | |
| Epotuf 37-681 | 150.0 | | |
| Arcosolve PTB | 16.0 | | |
| Water | 216.0 | | |
| | 935.0 | | |

### EXAMPLE 5

Formulation #5

| Component A | | Component B | |
|---|---|---|---|
| Material | Lbs | Material | Lbs |
| Epotuf 37-680 | 159.0 | Epoxy Silane | 60 |
| Arcosolve PTB | 2.0 | Ektosolve EB | 20 |
| Dowanol PPh | 9.6 | | 80 |
| Red Iron Oxide | 81.0 | | |
| Wollastokup 10ES | 268.0 | | |
| | -Mix and Grind- | | |
| Epotuf 37-680 | 193.0 | | |
| Arcosolve PTB | 48.0 | | |
| Water | 15.0 | | |
| | 806.0 | | |

A typical composition of the present invention, as set forth in the examples, has a usable service temperature range of approximately −65 to 350° F.; a minimum pencil hardness of 2 H; impact resistance of 80 in/lb Gardner; flexibility of 180° measured by a conical mandrel; good sealant compatibility and good chemical resistance. A typical material cures at 77° F. and 50% relative humidity to a dust free state within thirty minutes, and is dry to tape or overcoat at two hours, and reaches a full cure in seven days.

It will be understood that in accord with the present invention, numerous other formulations may be readily implemented by one of skill in the art. It is the following claims, including all equivalents, which define the scope of the invention.

1. A water based, low VOC coating composition comprising:
(a) an aqueous dispersion of an amine terminated epoxy resin; and
(b) an organosilane curing agent of the formula:
R¹—(CH₂)ₓ—Si—(R³)_{n-N}—(R²)₃₋ₙ; wherein R¹ is an epoxide, an isocyanate, or an acrylic; R² is an alkoxy group, acetoxy group, or an oximino group; R³ is a C₁—C₆ alkyl group; X is an integer from 2-10; and n is 0 to 2.

2. A composition as in claim 1, wherein said aqueous dispersion of an amine terminated epoxy resin comprises an aqueous based microgel of said resin.

3. A composition as in claim 1, wherein said aqueous dispersion of an amine terminated epoxy resin comprises an aqueous emulsion of said resin.

4. A composition as in claim 1, wherein said organosilane curing agent comprises an epoxy silane.

5. A composition as in claim 1, wherein said organosilane curing agent is selected from the group consisting of gamma-glycidoxypropyl trimethoxysilane; beta-(3,4-epoxycyclohexyl)-ethyltrimethoxy silane; gamma-methacryloxypropyl trimethoxysilane; gamma-isocyanatopropyl triethoxysilane; and combinations thereof.

6. A composition as in claim 1, wherein said aqueous dispersion further includes an organic co-solvent therein in an amount of up to 80% by weight.

7. A composition as in claim 1, wherein said organosilane curing agent further includes up to 50% by weight of water therein.

8. A composition as in claim 1, wherein said organosilane curing agent further includes 0-90% by weight of a co-solvent therein; 0-50% by weight of a pigment therein; and 0-10% by weight of a surfactant therein.

9. A coated article, said article coated with a composition comprising:
(a) an aqueous dispersion of an amine terminated epoxy resin; and
(b) an organosilane curing agent of the formula:
R¹—(CH₂)ₓ—Si—(R³)ₙ—(R²)₃₋ₙ; wherein R¹ is an epoxide, an isocyanate, or an acrylic; R² is an alkoxy group, acetoxy group, or an oximino group; R³ is a C₁—C₆ alkyl group; X is an integer from 2-10; and n is 0 to 2.

10. A coated article as in claim 9, wherein said aqueous dispersion of an amine terminated epoxy resin comprises an aqueous based microgel of said resin.

11. A coated article as in claim 9, wherein said aqueous dispersion of an amine terminated epoxy resin comprises an aqueous emulsion of said resin.

12. A coated article as in claim 9, wherein said organosilane curing agent comprises an epoxy silane.

13. A coated article as in claim 9, wherein said organosilane curing agent is selected from the group consisting of gamma-glycidoxypropyl trimethoxysiane; beta-(3,4-epoxycyclohexyl)-ethyltrimethoxy silane; gamma-methacryloxypropyl trimethoxysilane; gamma-isocyanatopropyl triethoxysilane; and combinations thereof.

14. A coated article as in claim 9, wherein said aqueous dispersion further includes an organic co-solvent therein in an amount of up to 80% by weight.

15. A coated article as in claim 9, wherein said organosilane curing agent further includes up to 50% by weight of water therein.

16. A coated article as in claim 9, wherein said organosilane curing agent further includes 0-90% by weight of a co-solvent therein; 0-50% by weight of a pigment therein; and 0-10% by weight of a surfactant therein.

17. A method for making a water based, low VOC coating composition, said method comprising the steps of:
combining a first component comprising a water based dispersion of amine terminated epoxy resin and a curing agent comprising an organosilane having the structure R¹—(CH₂)ₓ—Si—(R³)ₙ—(R²)₃₋ₙ; wherein R¹is an epoxide, an isocyanate, or an acrylic; R² is an alkoxy group, acetoxy group, or an oximino group; R³ is a C₁—C₆ alkyl group; X is an integer from 2-10; and n is 0 to 2.

18. A method as in claim 17, wherein the aqueous dispersion of an amine terminated epoxy resin comprises an aqueous based microgel of said resin.

19. A method as in claim 17, wherein the aqueous dispersion of an amine terminated epoxy resin comprises an aqueous emulsion of said resin.

20. A method as in claim 17, wherein the organosilane curing agent comprises an epoxy silane.

21. A method as in claim 17, wherein the organosilane curing agent is selected from the group consisting of gamma-glycidoxypropyl trimethoxysilane; beta-(3,4-epoxycyclohexyl)-ethyl trimethoxysilane; gamma-methacryloxypropyl trimethoxysilane; gamma-isocyanatopropyl triethoxysilane; and combinations thereof.

22. A method as in claim 17, wherein the aqueous dispersion further includes an organic co-solvent therein in an amount of up to 80% by weight.

23. A method as in claim 17, wherein the organosilane curing agent further includes up to 50% by weight of water therein.

24. A method as in claim 17, wherein the organosilane curing agent further includes 0-90% by weight of a co-solvent therein; 0-50% by weight of a pigment therein; and 0-10% by weight of a surfactant therein.
